(19) United States
(12) Patent Application Publication
(10) Pub. No.: US 2018/0108262 A1
(43) Pub. Date: Apr. 19, 2018

(54) FLEXIBLE TEACHING AID

(71) Applicant: John Davis, Anacortes, WA (US)

(72) Inventor: John Davis, Anacortes, WA (US)

(21) Appl. No.: 15/420,288

(22) Filed: Jan. 31, 2017

Related U.S. Application Data
(60) Provisional application No. 62/409,990, filed on Oct. 19, 2016.

(51) Int. Cl. G09B 1/00; G09B 23/02; G09B 23/00; G09B 11/00; G09B 19/06; B29C 39/02

(52) U.S. Cl. CPC G09B 1/00; G09B 23/02; B29C 39/026; G09B 11/00; G09B 19/06; G09B 23/00

(57) ABSTRACT

A teaching aid apparatus specially designed in the form of a human-like hand that reinforces learning of at least manual sign language alphabets. The teaching aid is posable, flexible, and can to depict various types of symbols and signs, where the hand-like structure is incorporated by posing materials which enhances tactile and kinesthetic learning. The disclosed teaching aid is capable of improving visual and memory perceptions and thereby beneficial for occupational and educational therapists, physical therapists, teachers and those working with individuals with unique learning needs.

### CROSS REFERENCE TO RELATED APPLICATION

Provisional application No. 62/409,990, filed on Oct. 19, 2016

### FEDERALLY SPONSORED RESEARCH AND DEVELOPMENT

Not Applicable

### MICROFICHE APPENDIX

Not Applicable

### BACKGROUND OF THE INVENTION

Child education begins as soon as a child starts observing his or her surroundings. Children's minds are very receptive during the early years of their life; it is always preferred to allow their learning to be a natural and playful process. Numerous teaching aids are available in the marketplace which advertise themselves as enhancing the development of a child's ability to understand the basics of disciplines such as language, math, and science. But yet, we see a deficiency in products which support the learning of individuals with unique learning circumstances, such as individuals suffering from neuro-degenerative diseases. The current invention discloses an innovative pliable teaching aid that is equipped accordingly to facilitate the learning of disciplines, such as sign language, English, art, science, social studies, and math.

As is common with instructional tools, they do not incorporate the improvement of motor skills, hand-eye coordination, and social interaction into the more traditional forms of teaching such as the learning of letters, numbers, shapes, symbols, and the like. Additionally, they do not combine intellectual and manipulative exercises in a manner which would reinforce both the mental and physical aspects of learning. Additionally, these tools provide little or no versatility. Thus a teaching aid that facilitates the learning of shapes generally could not also be used to teach letters, numbers, hand-eye coordination, motor control, and social interaction.

Hence there existed a long felt need for a new improved teaching aid convenient for use in teaching individuals, including those with unique learning needs, as a main teaching or supplementary tool to reinforce concepts.

### BRIEF SUMMARY OF THE INVENTION

The current invention disclosure discloses a hand like teaching aid that functions as an improved teaching aid for reinforcement of information in individuals, the teaching aid disclosed herein is flexible and is capable of depicting various types of symbols and signs, the human hand-like structure is incorporated by wires which supports tactile and kinesthetic learning methodologies.

The primary object of the current invention is to provide a teaching aid for individuals of different learning styles and abilities.

It is further an object of the invention to provide a versatile and colorful teaching aid well suited for arts integration into the curriculum.

It is also an object of the invention to provide a teaching aid that is capable of improving visual and memory perceptions.

It is also an object of the invention to provide a teaching aid that is compact, effective, and easy to use.

It is also an object of the invention to provide a teaching aid beneficial for occupational and educational therapists, physical therapists, teachers serving individuals of all types, including those with special needs.

Other objects of the present invention will become apparent to one skilled in the art throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some contemplated embodiments of the present invention, a more particular description of the invention will be rendered by reference to specific embodiments thereof which are illustrated in the appended drawings. It is appreciated that the drawings depict only illustrated embodiments of the invention and are therefore not to be considered limiting of its scope. The invention will be described and explained with additional specificity and detail through the use of the accompanying drawings in which:

FIG. 1 is a front perspective view of an embodiment of the present invention; and

FIG. 2 is a front sectional perspective view of the embodiment of the present invention in FIG. 1.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

In some preferred embodiments, the present invention provides a teaching aid beneficial for occupational and educational therapists, physical therapists, teachers, and individuals with unique learning needs. Embodiments of the invention reinforce learning of information, such as the learning of any language with a manual sign language alphabet, math, science, or art. Further, embodiments of the invention promote learning information through tactile and kinesthetic learning methodologies.

In one embodiment, the disclosed teaching aid is a representation of a human hand that is flexible and can be positioned into various types of symbols and signs used in a manual sign language alphabet. The invention contains a posing material, such as flexible wire which is enclosed in a medium representing the palm and the digits of the hand in order to allow movement of the digits and to pose, or bend, them into a desired arrangement in order to mimic an intended symbol or sign. Once posed, the digits stay in their bent configuration until changed by a user. Further, digits may be bent in any direction, both natural to a real human hand and un-natural. It is contemplated the hand may appear more abstract or simplistic than an actual human hand but will contain same five digits, that is four fingers and a thumb, as well as a range of movement of the digits substantially similar as that of a human hand.

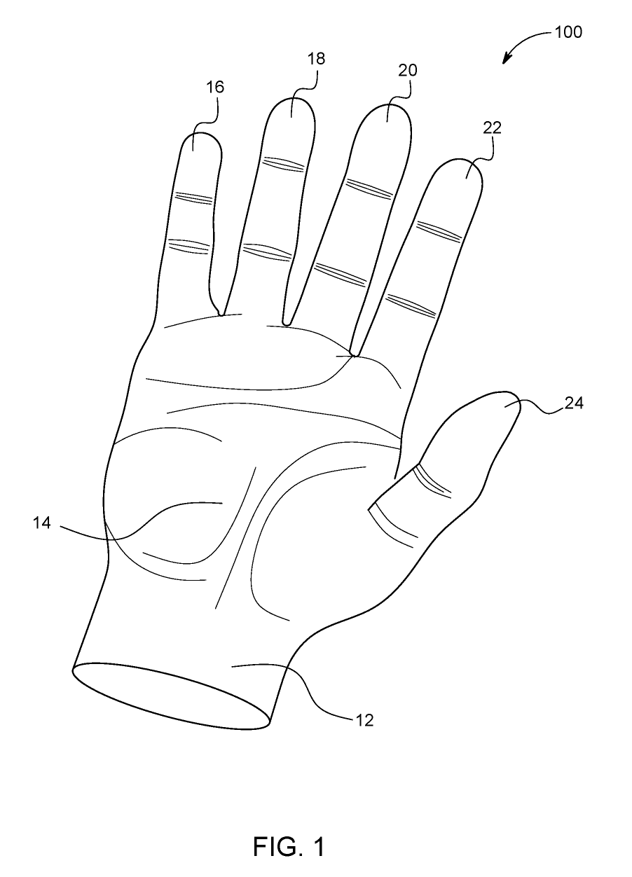

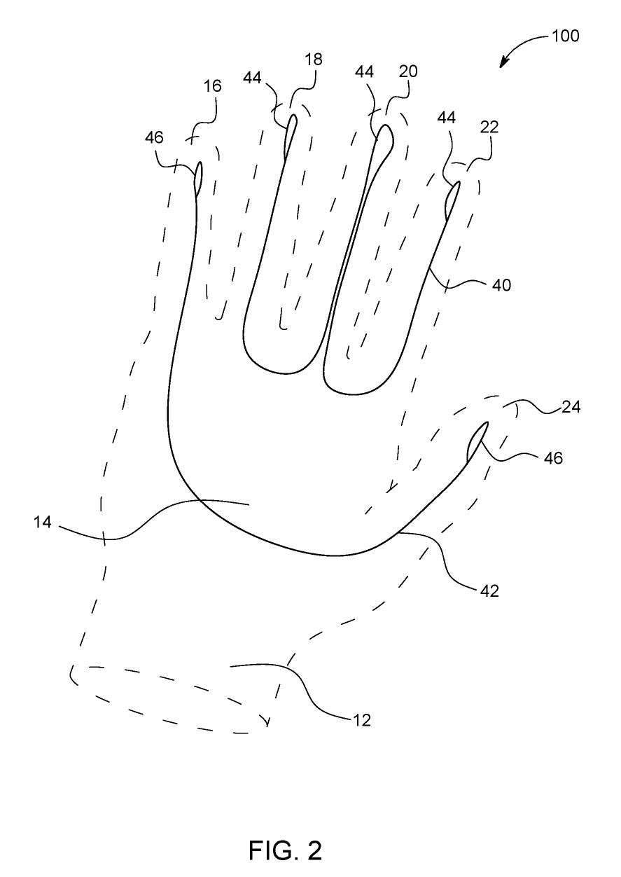

With reference now to the drawings, FIG. 1 and FIG. 2 illustrates an embodiment of the teaching aid apparatus designated generally by the reference character 100. Teaching aid apparatus 100 comprises a wrist like structure 12, a palm like structure 14, a pinky finger like structure 16, a ring finger like structure 18, a middle finger like structure 20, an index finger like structure 22, and a thumb like structure 24. The finger like structures 16, 18, 20, 22, and thumb like structure 24 are preferred to mimic the length and shape of an average Caucasian male adult human hand, but it is contemplated the apparatus 100 can be created to resemble any race, age, or gender of human hand in appearance or function. The shape of apparatus 100 is comprised of a castable flexible material such as foam, urethane, silicon, or other material known in the art to be pliable and flexible. One such castable material that could be used is known under the trademark, Flex Foam-It III®. The teaching aid could be made any desired size but a preferred embodiment has the shape of the an anglo-saxon male human hand and is 9 inches tall by 6 inches wide by 1.5 inches deep. It is contemplated the teaching aid 100 may include at a minimum at least one finger like structure and a palm if desired.

It is contemplated the apparatus 100 could be any desired color. A coloring agent such as urethane tint could be mixed completely into the castable flexible material during manufacturing. One such coloring material that could be used is known under the trademark, So-Strong®. It is further contemplated additional materials could be added to the castable material to induce a desired texture, such as sand or rocks, or characteristic such as glow-in-the-dark properties.

Further, as shown in FIG. 2, apparatus 100 further comprises a flexible posing material 40 and 42 to pose finger like structures 16, 18, 20, 22, thumb like structure 24, and palm like structure 14 into a desired symbol, shape, or position. Such material includes a continuous flexible wire comprised of metal wire such as copper; mechanics wire, such as bailing wire or soft wire; or another flexible wire material such as synthetic or biodegradable plastic. The diameter of the wire could be any diameter which allows the finger structures, palm, and thumb structure to be posed and maintained, but the preferred embodiment comprises 14 gauge for posing material 42, and 16 gauge wire for posing material 40; because each wire gauge provides different flexibility, resilience, and stiffness while providing the ability to easily pose the desired structure. The different gauges of posing material 40 and posing material 42 also provide different resistance levels to a user and provide additional stimulus to help reinforce learning of concepts. Further, posing material 42 is a heavier gauge in order to hold the shape of the apparatus due to the density of the castable material. Posing material 40 allows structures 18, 20, and 22 to be posed as desired while posing material 42 allows finger like structure 16, palm like structure 14, and like structure thumb 24 to be posed as desired. Posing material 40 is preferably comprised of 16 gauge flexible wire and made into a zig-zag, or “W” shape. Each end of the “W” shape as well as the tip of shape comprising the tip of middle finger 20 are bent into a rounded loop shape 44 to protect material 40 from poking or protruding out of apparatus 100 due to use. The length of posing material 40 inside finger like structures 18, 20, and 22 is ideally no longer than the summation of the length of each structure to avoid protrusion of posing material 40 outside each corresponding finger structure. Further, posing material 42 is preferably comprised of 14 gauge material and bent into a “U” shape and also has both ends 46 bent into the same rounded loop shape, as posing material 40, to protect material 42 from protruding through the castable material of finger structure 16 and thumb structure 24. The length of ends 46 is ideally no longer than the summation of the length of finger structure 16, width of palm 14, and length of thumb structure 24. Posable material 40 and 42 are ideally positioned transversely along the length of the apparatus 100 and located centrally inside each finger, palm, and thumb structure. This positioning ensures posable material 40 and 42 are not viewable by a user and that each finger structure, palm, and thumb can be posed as desired.

Further a method is disclosed for creating apparatus 100 by first creating a two-piece mold of the desired hand shape comprising four fingers, a thumb, a palm, and a wrist, using metal, wood, silicon, or other common molding materials known in the art. The two-piece mold may be comprised of silicone rubber or other desired material composition. Next a first support structure configured for posing the first, second, and third fingers; and a second support structure is configured for posing the fourth finger, thumb, and palm. The first finger may be a ring finger, the second finger may be a middle finger, the third finger may be an index finger, and the fourth finger may be a pinky finger. Both support structures are located equidistant from the top and bottom surface of the hand shape, and set centrally transverse along the length of the mold. The support structures are secured into place by any commonly known means, such as metal pins, which are subsequently removed after molding is completed. Next, the 2-piece mold is secured together ideally with clamps, a heavy weight, or clips, and an effective amount of castable material is prepared and poured into the mold. The temperature of the castable material is then maintained at a specific level for an amount of time to cure the castable material. In one case the material is kept at 73 degrees Fahrenheit for a time period of 2 hours. After the castable material has been cast, the mold is removed and any imperfections are sanded or cut down. Removal of the apparatus from the mold is done slowly and with care to reduce the changes of damage to the apparatus. Last, a securing material may be permanently or removably attached to the bottom wrist portion of the apparatus in order to anchor the apparatus to a surface, thereby allowing the apparatus to stand upright. Such contemplated securing materials are Velcro or double sided tape.

As may now be appreciated from the above description and reference to the accompanying drawings, the present invention provides a teaching aid which may be utilized to reinforce the learning in students and differently-abled individuals for improving visual and memory perceptions.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for making a teaching aid apparatus having a human hand-like structure with four fingers, a palm, and a thumb comprising: creating a two-piece mold of a human hand-like structure; securing a first support structure configured for posing the first, second, and third fingers; securing a second support structure configured for posing the fourth finger, the palm, and the thumb; securing the mold together; preparing an effective amount of castable material; pouring the effective amount of castable material into the mold; curing the castable material; and removing the apparatus from the mold.

2. The method for making the teaching aid apparatus as claimed in claim 1, wherein the first finger is a ring finger, the second finger is a middle finger, and the third finger is an index finger.

3. The method for making the teaching aid apparatus as claimed in claim 1, wherein the fourth finger is a pinky finger.

4. The method for making the teaching aid apparatus as claimed in claim 1, wherein the first support structure is comprised of continuous 16 gauge solid copper core wire.

5. The method for making the teaching aid apparatus as claimed in claim 4, wherein the ends of the wire are bent into circles.

6. The method for making the teaching aid apparatus as claimed in claim 1, wherein the second support structure comprises a continuous 14 gauge solid copper core wire.

7. The method for making the teaching aid apparatus as claimed in claim 1, wherein the castable material comprises a flexible urethane foam and a color additive.

8. The method for making the teaching aid apparatus as claimed in claim 1, wherein the castable material comprises a texture additive.

9. A teaching aid apparatus in the shape of a posable hand comprising:
a pinky finger like structure;
a ring finger like structure;
a middle finger like structure;
an index finger like structure;
a thumb like structure;
a palm like structure;
a wrist like structure;
a first continuous support structure for posing the ring finger like structure, middle finger like structure, and index finger like structure, wherein the structure is located within the ring finger like structure, middle finger like structure, and index finger like structure; and
a second continuous support structure for posing the pinky finger like structure, palm like structure, and thumb like structure, wherein the structure is located within the pinky finger like structure, palm like structure, and thumb like structure.

10. The teaching aid apparatus of claim 9 wherein the hand is a human hand.

11. The teaching aid apparatus of claim 9 wherein the pinky finger like structure, ring finger like structure, middle finger like structure, index finger like structure, thumb like structure, palm like structure, and wrist like structure are comprised of:
a flexible castable material; and
a coloring agent dispersed completely throughout the castable material.

12. The teaching aid apparatus of claim 9 wherein the first support structure for posing the ring finger like structure, middle finger like structure, and index finger like structure is comprised of 16 gauge wire.

13. The teaching aid apparatus of claim 11 wherein the castable material is a flexible urethane foam.

14. The teaching aid apparatus of claim 11 wherein the coloring agent is an urethane tint.

15. The support structure of claim 12 wherein the first structure is configured in a W shape.

16. The teaching aid apparatus of claim 9 wherein the second support structure for posing the pinky finger like structure, palm like structure, and thumb like structure is comprised of 14 gauge wire.

17. The support structure of claim 16 wherein the second structure is configured in a U shape.

18. A teaching aid apparatus in the shape of a posable hand comprising:
at least one finger like structure;
a palm like structure;
a first continuous support structure for posing the ring finger like structure, middle finger like structure, and index finger like structure, wherein the structure is located within the ring finger like structure, middle finger like structure, and index finger like structure; and
a second continuous support structure for posing the pinky finger like structure, palm like structure, and thumb like structure, wherein the structure is located within the pinky finger like structure, palm like structure, and thumb like structure.

19. The teaching aid apparatus in the shape of a posable hand in claim 18 further comprising a wrist like structure.
